(19) United States
(12) Patent Application Publication
(10) Pub. No.: US 2010/0112940 A1
(43) Pub. Date: May 6, 2010

(54) APPARATUS AND METHOD FOR IMPROVING DATA TRANSMISSION SPEED OF TERMINAL TRANSMITTING DATA USING NEAR FIELD COMMUNICATION SCHEME

(75) Inventor: Young-Ho Yoon, Suwon-si (KR)

Correspondence Address: Jefferson IP Law, LLP, 1130 Connecticut Ave., NW, Suite 420, Washington, DC, 20036, US

(73) Assignee: Samsung Electronics Co., Ltd., Suwon-si (KR)

(21) Appl. No.: 12/504,423

(22) Filed: Jul. 16, 2009

(30) Foreign Application Priority Data
Nov. 5, 2008 (KR) 10-2008-0109403

(51) Int. Cl. H04B 5/00

(52) U.S. Cl. 455/41.1

(57) ABSTRACT

An apparatus and a method for improving data transmission speed in a terminal transmitting data using a Near Field Communication (NFC) scheme are provided. The method includes measuring NFC power, detecting a modulation scheme corresponding to the measured NFC power from an approximate power table, modulating data using the detected modulation scheme, and transmitting the modulated data using the NFC scheme.

### PRIORITY

This application claims the benefit under 35 U.S.C. §119(a) of a Korean patent application filed in the Korean Intellectual Property Office on November 5, 2008 and assigned Serial No. 10-2008-0109403, the entire disclosure of which is hereby incorporated by reference.

### BACKGROUND OF THE INVENTION

1. Field of the Invention

The present invention relates to an apparatus and a method for transmitting data using a Near Field Communication (NFC) scheme. More particularly, the present invention relates to an apparatus and a method for improving data transmission speed of a terminal transmitting data using an NFC scheme.

2. Description of the Related Art

As communication apparatuses and equipment develop, mobile communication terminals have become an essential element to everyday life. As a result, communication terminal services requiring high bandwidth, such as Electronic (E)-mail, Digital Multimedia Broadcasting (DMB), Digital Audio Broadcasting (DAB) and Digital Video Broadcasting-Handheld (DVB-H), have increased. Also, as personal mobile communication terminals such as cellular phones and Personal Digital Assistants (PDAs) are used, a short distance communication scheme is necessary which does not need a base station.

Near Field Communication (NFC) is a type of Radio Frequency IDentification (RFID) which is a short distance communication scheme that does not need a base station. The NFC is a non-contact wireless communication technique which may transmit data using a simple process and low power within a maximum distance of 20 cm via a frequency of 13.56 MHz. According to the NFC, when two or more terminals are put close to each other, even without artificial manipulation of a user, basic information, such as a phone number, and data, such as an MP3 file and images, may be transmitted and received between the terminals. The NFC supports transmission speeds of 106 kbps, 212 kbps and 424 kbps, and is currently applied to a personal mobile communication apparatus, such as a cellular phone. However, since the NFC uses a fixed modulation scheme (for example, Amplitude Shift Keying (ASK) and Phase Shift Keying (PSK)), transmission speed is low.

According to a long distance communication scheme which uses a general cellular phone network, such as Global System for Mobile communications (GSM), General Packet Radio Service (GPRS) and Code Division Multiple Access (CDMA), data transmission speed and a Bit Error Rate (BER) vary depending on time and space due to a path loss by multipath fading. Therefore, a base station determines the BER and control power, and transmits data using a fixed modulation method. In a case of using a cellular phone network, such as High-Speed Downlink Packet Access (HSDPA), a base station transmits data using an AMC scheme. That is, the base station determines a target BER and power, and transmits data using a modulation scheme suitable for the power.

As described above, in a data transmission scheme which uses a conventional cellular phone network, a base station exists and a complicated process may be applied to the conventional cellular phone network. Accordingly, a transmission speed may be increased to meet circumstances of the complicated process. However, in an NFC scheme which uses a Point-to-Point scheme without a base station, a complicated process is difficult to apply. Therefore, the NFC has a limit in transmission speed due to a simple communication process and low power.

Therefore, a need exists for an apparatus and method for improving data transmission speed of a communication terminal.

### SUMMARY OF THE INVENTION

An aspect of the present invention is to address at least the above-mentioned problems and/or disadvantages and to provide at least the advantages described below. Accordingly, an aspect of the present invention is to provide an apparatus and a method for improving data transmission speed of a terminal which transmits data using a Near Field Communication (NFC) scheme.

Another aspect of the present invention is to provide an apparatus and a method for improving data transmission speed of a terminal which transmits data using an NFC scheme by generating an approximate power table representing a power threshold for each modulation scheme using an approximate Bit Error Rate (BER) equation, and applying Adaptive Modulation & Code (AMC) to the NFC scheme using the approximate power table.

In accordance with an aspect of the present invention, a data transmission method using a NFC scheme in a mobile communication terminal is provided. The method includes measuring NFC power, detecting a modulation scheme corresponding to the measured NFC power in an approximate power table, modulating data using the detected modulation scheme, and transmitting the modulated data using the NFC scheme.

In accordance with another aspect of the present invention, a data transmission apparatus using an NFC scheme in a mobile communication terminal is provided. The apparatus includes an NFC power measuring unit for measuring NFC power, a storage unit for storing an approximate power table, a modulation scheme detector for detecting a modulation scheme corresponding to the measured NFC power from the approximate power table, and an NFC communication unit for modulating data using the detected modulation scheme and for transmitting the modulated data using the NFC scheme.

In accordance with another aspect of the present invention, a data transmission apparatus using an NFC scheme in a mobile communication terminal is provided. The apparatus includes an NFC power measuring unit for measuring NFC power, a modulation scheme detector for extracting an approximate power table from a storage unit and detecting a modulation scheme corresponding to the measured NFC power from the approximate power table, and an NFC communication unit for modulating data using the detected modulation scheme, and for transmitting the modulated data using the NFC scheme.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is a block diagram illustrating an apparatus of a terminal for transmitting data using a Near Filed Communication (NFC) scheme according to an exemplary embodiment of the present invention;

FIG. 2 is a flowchart illustrating a method for allowing a terminal to transmit data using an NFC scheme according to an exemplary embodiment of the present invention; and

FIG. 3 is a graph comparing a conventional Adaptive Modulation & Coding (AMC) applying method with an AMC applying method using an approximate power table according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention provide an apparatus and a method for improving data transmission speed of a terminal which transmits data using a Near Field Communication (NFC) scheme by generating an approximate power table representing a power threshold for each modulation scheme using an approximate Bit Error Rate (BER) equation, and applying Adaptive Modulation & Coding (AMC) to the NFC scheme using the approximate power table.

In a case of the NFC, since communication is performed using Line Of Sight (LOS) in a short distance range within a maximum of 20 cm, multipath fading does not exist. Therefore, a BER determination and complicated power control are not used in real-time during data communication. Instead, an approximate power table representing a power threshold for each modulation scheme using an approximate BER equation may be generated, and then AMC may be applied to the NFC scheme using the approximate power table.

Assuming that the number of bits which may be transmitted per symbol in an NFC system is n, a power threshold which may transmit n bits per symbol for T times may be determined using Equation (1) below.

$${γ}_{T}^{n} = B E {R}_{n}^{- 1} ( 0.001 ) \qquad ( 1 )$$

In an exemplary implementation, when Equation (1) is arranged in terms of BER of n-ary Quadrature Amplitude Modulation (QAM), assuming that a minimum BER (target BER), i.e., BER₀, which may perform communication, is a constant, Equation (1) may be expressed as an approximate BER equation shown in Equation (2).

$${γ}_{T}^{n} = - \frac{2}{3} ln ( 5 B E {R}_{0} ) ( {2}^{n} - 1 ) \qquad ( 2 )$$

In Equation (2), BER₀ is variably set depending on the type of data. Therefore, Equation (2) may generate an approximate power table representing a power threshold for each modulation scheme using the approximate BER equation shown in Equation (2).

For example, assuming that BER₀=0.0001, the approximate power table may be generated as in Table 1 below.

TABLE 1

| n (Spectral Efficiency) | γ_{T}ⁿ [dB] | Modulation |
|---|---|---|
| 1 | 5.4805 | BPSK |
| 2 | 10.2517 | QPSK |
| 3 | 13.9314 | 8QAM |
| 4 | 17.2414 | 16QAM |
| 5 | 20.3914 | 32QAM |
| 6 | 23.4739 | 64QAM |
| 7 | 26.5185 | 128QAM |
| 8 | 29.5459 | 256QAM |

Therefore, during data transmission, AMC may be applied to the NFC scheme using the approximate power table without BER determination and power control. That is, a terminal which intends to transmit data using the NFC scheme measures NFC power and compares the measured NFC power with a power threshold of the approximate power table as in Equation (3).

r_{T}ⁿ≦NFCPower <r_{T}ⁿ⁺¹ (3)

Here, in the case where a maximum value is set to n in the approximate power table, since n+1 does not exist, r_{T}ⁿ≦NFCPower needs to be met rather than Equation (3). Subsequently, r_{T}ⁿ meeting Equation (3) is searched and a modulation scheme corresponding to the r_{T}ⁿ searched from the approximate power table is detected. Data is then modulated and transmitted using the detected modulation scheme.

For example, in a case of using the approximate power table shown in Table 1, a modulation scheme of data is detected as described below and data may be modulated and transmitted.
5.4805≦NFC power<10.2517 [symbol] modulate using Binary Phase-Shift Keying (BPSK)
10.2517≦NFC power<13.9314 [symbol] modulate using Quadrature Phase-Shift Keying (QPSK)
13.9314≦NFC power<17.2414 [symbol] modulate using 8 QAM
17.2414≦NFC power<20.3914 [symbol] modulate using 16 QAM
20.3914≦NFC power<23.4739 [symbol] modulate using 32 QAM
23.4739≦NFC power<26.5185 [symbol] modulate using 64 QAM
26.5185≦NFC power<29.5459 [symbol] modulate using 128 QAM
29.5459≦NFC power [symbol] modulate using 256 QAM

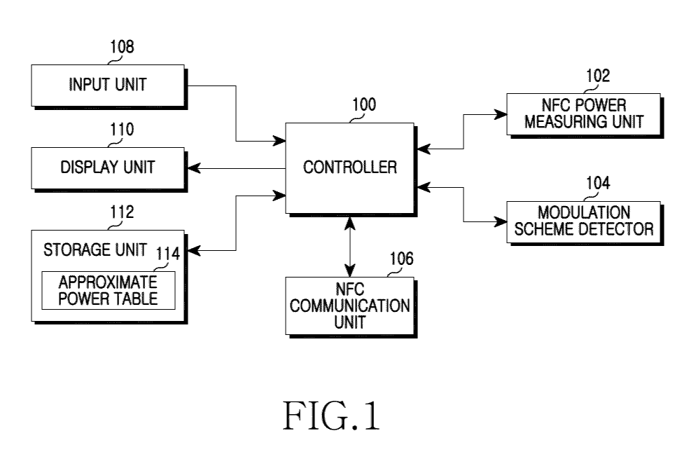

FIG. 1 is a block diagram illustrating an apparatus of a terminal for transmitting data using an NFC scheme according to an exemplary embodiment of the present invention.

As illustrated in FIG. 1, the terminal includes a controller 100, an NFC power measuring unit 102, a modulation scheme detector 104, an NFC communication unit 106, an input unit 108, a display unit 110 and a storage unit 112.

Referring to FIG. 1, the controller 100 performs a control and process for an overall operation of the terminal. More particularly, the controller 100 performs a control and process for improving data transmission speed of the terminal which transmits data using an NFC scheme by applying AMC to the NFC scheme using an approximate power table 114.

The NFC power measuring unit 102 measures NFC power according to a user's selection of a data transmission menu which uses the NFC scheme.

The modulation scheme detector 104 extracts the approximate power table 114 from the storage unit 112 according to the user's selection of the data transmission menu which uses the NFC scheme. The modulation scheme detector 104 then detects a modulation scheme corresponding to the NFC power measured by the NFC power measuring unit 102 from the extracted approximate power table 114. That is, the modulation scheme detector 104 compares a power threshold for each modulation scheme with the measured NFC power using the extracted approximate power table 114, thereby determining whether the measured NFC power meets Equation (3). When the measured NFC power meets Equation (3), the modulation scheme detector 104 detects a modulation scheme which meets Equation (3) and corresponds to r_{T}ⁿ from the approximate power table 114.

The NFC communication unit 106 transmits/receives data to/from a different terminal located in an area where data transmission using the NFC scheme is possible. More particularly, the NFC communication unit 106 modulates data using the modulation scheme detected by the modulation scheme detector 104, and transmits the modulated data using the NFC scheme.

The input unit 108 includes a plurality of function keys, and provides data corresponding to a key pressed by the user to the controller 100. The display unit 110 displays state information, numbers and letters generated during an operation of the terminal.

The storage unit 112 stores programs used for an overall operation of the terminal and various information. More particularly, the storage unit 112 stores the approximate power table 114. Here, the approximate power table 114 is a table regarding a power threshold for each modulation scheme. The power threshold for each modulation scheme may be determined using the approximate BER equation shown in Equation (2).

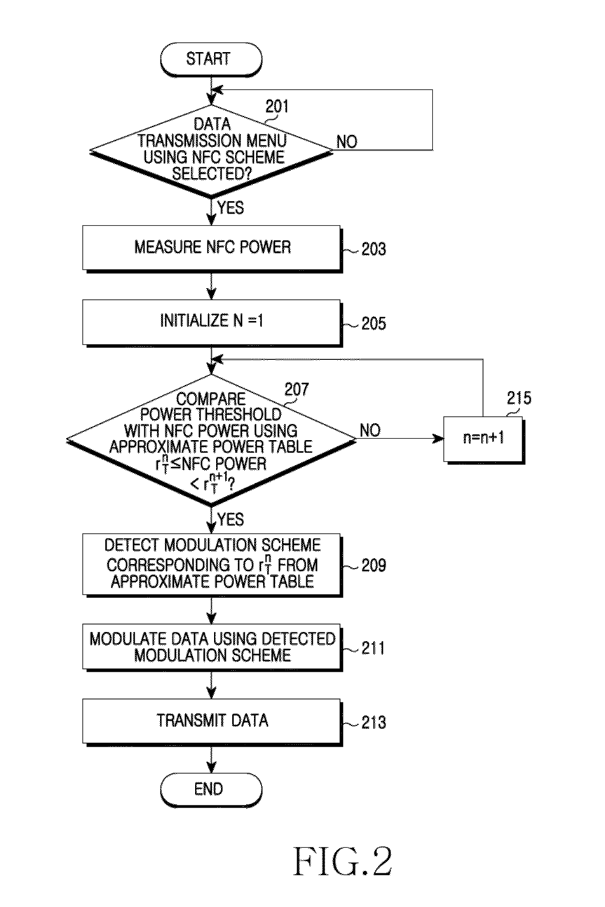

FIG. 2 is a flowchart illustrating a method for allowing a terminal to transmit data using an NFC scheme according to an exemplary embodiment of the present invention.

Referring to FIG. 2, in step 201, the terminal determines whether a data transmission menu which uses the NFC scheme is selected by a user's key manipulation. When the selection of the data transmission menu which uses the NFC scheme is detected, the terminal measures NFC power in step 203, and performs initialization by setting n=1 in step 205. Here, n denotes the number of bits which may be transmitted per symbol.

In step 207, the terminal determines whether the measured NFC power meets Equation (3) by comparing a power threshold for each modulation scheme with the measured NFC power using an approximate power table. When the measured NFC power does not meet Equation (3), the terminal replaces n by n+1 in step 215, and returns to step 207 to repeatedly perform subsequent steps.

On the other hand, when the measured NFC meets Equation (3), the terminal detects a modulation scheme corresponding to r_{T}ⁿ meeting Equation (3) from the approximate power table in step 209.

In step 211, the terminal modulates data using the detected modulation scheme, and in step 213, the terminal transmits the modulated data.

The terminal then ends the process.

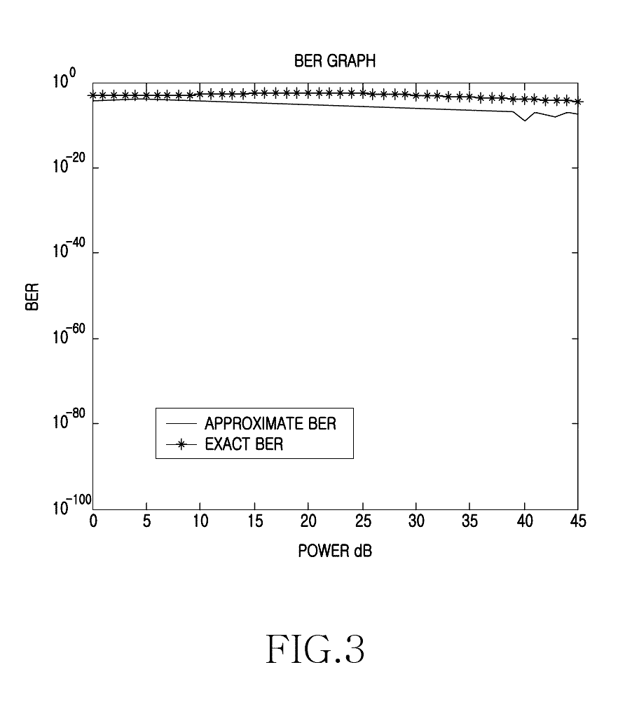

FIG. 3 is a graph comparing a conventional AMC applying method with an AMC applying method using an approximate power table according to an exemplary embodiment of the present invention.

Referring to FIG. 3, according to the conventional AMC applying method which uses a real BER, when 10000 bit-data per power of 0.5 dB is transmitted using 1024 QAM, a BER of 0.01% is generated. It is revealed that an AMC applying method which uses the approximate BER according to an exemplary embodiment of the present invention may generate a BER substantially similar to that of the conventional AMC applying method.

As described above, exemplary embodiments of the present invention may improve data transmission speed by generating an approximate power table representing a power threshold for each modulation scheme using an approximate BER equation, and applying AMC to the NFC scheme using the approximate power table, thereby applying the AMC using a simple process.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A data transmission method using a Near Field Communication (NFC) scheme in a mobile communication terminal, the method comprising:
measuring NFC power;
detecting a modulation scheme corresponding to the measured NFC power using an approximate power table;
modulating data using the detected modulation scheme; and
transmitting the modulated data using the NFC scheme.

2. The method of claim 1, wherein the approximate power table comprises a table representing a power threshold for each modulation scheme.

3. The method of claim 2, wherein the power threshold is determined using an approximate Bit Error Rate (BER) equation shown below:
$${γ}_{T}^{n} = - \frac{2}{5} ln ( 5 B E {R}_{0} ) ( {2}^{n} - 1 )$$
wherein n is a number of bits which is transmittable per symbol, r_{T}ⁿ is a power threshold which may transmit n bits per symbol for T times, and BER₀ is a target BER which performs communication, BER₀ being a constant.

4. The method of claim 2, wherein the detecting of the modulation scheme comprises:
determining whether the measured NFC power is included within a range between a k-th power threshold and a (k+1)-th power threshold of the approximate power table; and
when the measured NFC power is included within the range, detecting a modulation scheme corresponding to the k-th power threshold from the approximate power table.

5. A data transmission apparatus using a Near Field Communication (NFC) scheme in a mobile communication terminal, the apparatus comprising:
an NFC power measuring unit for measuring NFC power;
a storage unit for storing an approximate power table;
a modulation scheme detector for detecting a modulation scheme corresponding to the measured NFC power from the approximate power table; and
an NFC communication unit for modulating data using the detected modulation scheme, and for transmitting the modulated data using the NFC scheme.

6. The apparatus of claim 5, wherein the approximate power table comprises a table representing a power threshold for each modulation scheme.

7. The apparatus of claim 6, wherein the power threshold is determined using an approximate Bit Error Rate (BER) equation shown below:
$${γ}_{T}^{n} = - \frac{2}{3} ln ( 5 B E {R}_{0} ) ( {2}^{n} - 1 )$$
wherein n is a number of bits which is transmittable per symbol, r_{T}ⁿ is a power threshold which may transmit n bits per symbol for T times, and BER₀ is a target BER which performs communication, BER₀ being a constant.

8. The apparatus of claim 6, wherein the modulation scheme detector comprises:
a unit for determining whether the measured NFC power is included within a range between a k-th power threshold and a (k+1)-th power threshold of the approximate power table; and
a unit for, when the measured NFC power is included within the range, detecting a modulation scheme corresponding to the k-th power threshold from the approximate power table.

9. A data transmission apparatus using a Near Field Communication (NFC) scheme in a mobile communication terminal, the apparatus comprising:
an NFC power measuring unit for measuring NFC power;
a modulation scheme detector for extracting an approximate power table from a storage unit and detecting a modulation scheme corresponding to the measured NFC power from the approximate power table; and
an NFC communication unit for modulating data using the detected modulation scheme, and for transmitting the modulated data using the NFC scheme.

10. The apparatus of claim 9, wherein the approximate power table comprises a table representing a power threshold for each modulation scheme.

11. The apparatus of claim 10, wherein the power threshold is determined using an approximate Bit Error Rate (BER) equation shown below:
$${γ}_{T}^{n} = - \frac{2}{3} ln ( 5 B E {R}_{0} ) ( {2}^{n} - 1 )$$
wherein n is a number of bits which is transmittable per symbol, r_{T}ⁿ is a power threshold which may transmit n bits per symbol for T times, and BER₀ is a target BER which performs communication, BER₀ being a constant.

12. The apparatus of claim 10, wherein the modulation scheme detector comprises:
a unit for determining whether the measured NFC power is included within a range between a k-th power threshold and a (k+1)-th power threshold of the approximate power table; and
a unit for, when the measured NFC power is included within the range, detecting a modulation scheme corresponding to the k-th power threshold from the approximate power table.
